(19) United States
(12) Patent Application Publication
(10) Pub. No.: US 2006/0127533 A1
(43) Pub. Date: Jun. 15, 2006

(54) Bleaching of dairy products

(76) Inventors: Andre Leonardus de Roos, Delft (NL); Albertus Alard van Dijk, Vlaardingen (NL); Baukje Folkertsma, Delft (NL)

Correspondence Address: NIXON & VANDERHYE, PC, 901 NORTH GLEBE ROAD, 11TH FLOOR, ARLINGTON, VA, 22203, US

(21) Appl. No.: 10/559,787

(22) PCT Filed: Jul. 1, 2004
(86) PCT No.: PCT/EP04/07292

§ 371 Date: Dec. 8, 2005

(30) Foreign Application Priority Data
Jul. 2, 2003 (EP) 03077072.1

(51) Int. Cl. A23C 9/12; A21D 2/00

(52) U.S. Cl. 426/42; 426/539

(57) ABSTRACT

The present invention provides a method for bleaching or whitening a dairy product, comprising adding a lipoxygenase (LOX) to the dairy product. The method of the invention may be used to whiten milk, cheese, butter oil, cream or whey products. The invention further provides the use of a LOX to bleach a dairy product and a dairy product whitened by the methods of the invention.

### FIELD OF THE INVENTION

Milk and milk related products are an important part of human nutrition. Milk products contain several nutrients, which are consumed by humans to improve health and aid growth. The extent to which the milk or milk related products are white (“whiteness”) affects the perception of its taste and mouthfeel. Whiteness plays an important role in, for example, cheese, butter oil, milk powder or whey products. For example, whiteness is considered desirable for cheeses like Feta, Mozzarella, Ricotta and blue cheese. Cheeses in which the goat or sheep milk is at least partially replaced by cow's milk may be less white because of the β-carotene that is present in cow's milk.

For some cheeses, natural colouring agents like annatto or β-carotene are used as food colouring agents. However, this colouring agent will also be present in the whey. The colour of the processed whey product, for example baby formula, may therefore be undesirable.

Several methods are used to whiten milk or milk related products.

Titanium dioxide (TiO₂) is an inorganic, inert white pigment that is used in candies, chewing gum, tooth paste etc. and has been approved by the FDA as food grade. TiO₂ is added to cheese milk in concentrations of 0.02 to 0.05% depending on the type of milk and the season (S. Laakso & E -M Lilius., J. Agric. Food Chem., 1982, 30, 913-91). Buffalo milk is generally used to make Mozzarella cheese. However, there is far too little available to satisfy the current demand for Mozzarella and therefore Buffalo milk is at least partially replaced by cow's milk. However, Buffalo milk does not contain β-carotene, in contrast to cow's milk. Addition of TiO₂ in prescribed amounts does not affect taste and texture of the cheese. However, off-flavour development in Feta cheese following the addition of TiO₂ has been reported (F. Kosikowski & D. P. Brown. J. Dairy Sci. 52, No. 7 968-970).

Another method of whitening milk or milk related products involves the use of Benzoyl peroxide. This agent is used in the manufacture of Mozzarella, blue cheeses and certain Italian cheeses (F. Statens & Hilleroed., Beret.—Statens Forsoegsmejiri., 1978, 232, 3) at concentrations of 0.001 to 0.002%. The method is time consuming because the cream is usually separated from the cheese milk and treated with this agent at 63° C., for 45 to 120 minutes. The peroxide is highly inflammable and contact with the skin should be avoided. Benzoyl peroxide is also used in bleaching of waxes, soaps, fats (including butterfat) and bread. Benzoyl peroxide destroys β-carotene to such an extent that cheese milk or cheese need to then be supplemented with vitamin A. Moreover, it may produce off-flavours.

The use of chlorophylls for cheese whitening has also been described (F. Statens & Hilleroed., Beret.—Statens Forsoegsmejiri., 1978, 232, 3). The chlorophylls absorb the yellow colour of the beta-carotene resulting in a net decolouring of the cheese. The dosage of chlorophyll is critical; a small excess of the chlorophyll results in an undesirable greenish colour of the cheese. The dosage is the principle problem during cheese production, which makes the use of chlorophyll unattractive. In addition, questions have been raised about the long-term effects of chlorophylls on humans.

Other methods for whitening cheese are process related. Microfluidization of the cheese milk or its separated cream results in Cheddar cheese with a whiter appearance. However, cheese yield as well as fat and water retention in the curd and concomitantly cheese texture were affected (A. Lemay et al., J. Dairy Science, 1994, 77:2870-2879). In another process, separated butter oil is heat treated in order to destroy the β-carotene. This treatment may however lead to production of toxic oxysterols (J. H. Nielsen et al., 1996, 63, 615-621). To overcome the above-mentioned problems, the present invention discloses the use of lipoxygenases to bleach or whiten dairy products.

### SUMMARY OF THE INVENTION

Accordingly, the present invention provides a method for bleaching or whitening of a dairy product comprising incorporating or adding lipoxygenase (LOX) into the dairy product. The invention also provides the use of a LOX to bleach a dairy product. The invention further provides a dairy product which is bleached by LOX or a method of the invention and a dairy product comprising a LOX.

### DETAILED DESCRIPTION OF THE INVENTION

The present invention is based on the surprising finding that only small amounts of lipoxygenases have a whitening effect on dairy products such as milk, cheese, butter oil, cream, whey products. Dairy products are products that contain at least 10 w/w %, preferably at least 30 w/w %, more preferably at least 50 w/w %, still more preferably at least 70 w/w % or most preferably at least 80 w/w % on dry solid basis of components of milk, preferably cow's milk. Components of milk are, for example, fats, proteins etc. As discussed above milk, especially cow's milk may naturally contain colouring compounds such as β-carotene. The mechanism of bleaching by lipoxygenase is based on the oxidative transition of double bonds in β-carotene (or other carotenoides or other compounds having double bounds) by radicals produced in the reaction of lipoxygenase and linole(n)ic acid.

In contrast, the enzymatic whitening of the present invention may not result in off-flavours that might affect the taste of the treated dairy product. The whitening effect of lipoxygenase in dairy products is particularly surprising because the enzyme is present in the aqueous phase whereas the fatty acids are present in fat particles of the dairy product. Also, the beta-carotene, which is present in cow's milk, is present in the fat phase.

Commercially available lipoxygenase can be used. Soy is a well-known source of lipoxygenase. Other suitable sources include wheat varieties like durum, pea, faba beans, rice and lentils. Lipoxygenase may also be produced by fermentation. B. Knust (1990) Proc. 15^{th} fermentively Int. Conf. Yeast. Gen Mol. Biol. p. S429 describes the use of baker's yeast for producing legume lipoxygenase. Also, WO 02/20730 describes the production of lipoxygenase by the fungus Gaeumannomyces graminis, the identification of a lipoxygenase encoding gene from this organism and attempts to produce the functional protein in various microbial hosts. Soy derived lipoxygenase has been used for bleaching purposes in wheat and maize flour or in such applications as noodles (see e.g. JP1257158, JP53024039, JP5131358, JP530294), but its use for cheese whitening has not been described.

Therefore, lipoxygenase originating from animals, preferably mammals, plant or micro organisms can be used. Preferably plant or microbial LOX is used in the process of the invention. Most preferably LOX from soy is used for example LOX I-B.

Advantageously, the lipoxygenase is added to the milk before the cheese making process or any other milk conversion or separation process starts. The lipoxygenase can also be added at a later stage, for example during the cheese making such as at the same time as the addition of rennet. Alternatively, the lipoxygenase can be added onto the cheese after cheese manufacturing. Also, the lipoxygenase can be added to the whey or to the products obtained from whey, such as whey protein or whey hydrolysates.

It will be appreciated that the skilled person in the art can easily determine the amount of LOX necessary to whiten the dairy product. In general, from 10 to 1000 units of LOX per gram of dairy product, preferably from 50 to 500 units LOX per gram of dairy product, are used to bleach the dairy product.

### EXAMPLE 1

### Determination of lipoxygenase Acivity

Lipoxygenase from soy catalyzes the oxidation of lipids containing a cis,cis-1,4-pentadiene structure such a linoleic acid. The LOX activity was determined at pH 9.0 at 25° C. using linoleic acid as the substrate. One unit caused an increase of 0.001 absorbance units at 234 nm (1 cm path length) per minute.

### EXAMPLE 2

### Preparation of Lipoxygenase

Lipoxygenase was obtained from Sigma. Alternatively, lipoxygenase was prepared from soybean whey water, obtained from Protein Technology International (leper, Belgium). A solid/liquid separation was performed over a Z-2000 filter plate, followed by a germ filtration over a Z-200 Schenk filter plate. This resulted in a clear soy whey water preparation, which was subsequently ultra-filtrated at pH 8.2 on a 10 kD membrane. The final preparation contained at least •lipoxygenase units or more, the precise number varying between batches of soy whey.

### EXAMPLE 3

Preparation of Mini Cheeses

Miniature cheeses were produced as described by Shakeel-Ur-Rehman et al. (Protocol for the manufacture of miniature cheeses in Lait, 78 (1998), 607-620). Raw cows milk was pasteurised by heating for 30 minutes at 63° C. The pasteurised milk was transferred to wide mouth plastic centrifuge bottles (200 mL per bottle) and cooled to 31° C. Subsequently, 0.72 ml of starter culture DS 5LT1 (DSM Gist B. V., Delft, The Netherlands) was added to each of the 200 ml of pasteurised milk in the centrifuge bottles and the milk was ripened for 20 minutes. Then, CaCl₂ (132 μL of a 1 mol·L⁻¹ solution per 200 mL ripened milk) was added, followed by addition of the coagulant (0.04 IMCU per ml). In some cases the lipoxygenase was added together with the coagulant. The milk solutions were held for 40-50 minutes at 31° C. until a coagulum was formed. The coagulum was cut manually by cutters of stretched wire, spaced 1 cm apart on a frame. Healing was allowed for 2 minutes followed by gently stirring for 10 minutes. After that, the temperature was increased gradually to 39° C. over 30 minutes under continuous stirring of the curd/whey mixture. Upon reaching a pH of 6.2 the curd/whey mixtures were centrifuged at room temperature for 60 minutes at 1,700 g. The whey was drained and the curds were held in a water bath at 36° C. The cheeses were inverted every 15 minutes until the pH had decreased to 5.2-5.3 and were then centrifuged at room temperature at 1,700 g for 20 minutes. After further whey drainage, the miniature cheeses were brine salted (20% NaCl, 0.05% CaCl₂.2H₂O) for 30 minutes and stored at 12° C. until such time that the cheese colour was determined either by visual inspection or as described in Example 4.

### EXAMPLE 4

### Determination of Colour and Bleaching

Mini cheeses were scanned on a colour scanner (Hewlett Packard Scanjet ADF) and analysed using the programme LabSMART (LabSMART, LLC, Logan Utah, USA). Colours were quantified with three parameters: L-factor (black=0 to white=100), a-factor (green=− to red=+60) and b-factor (Blue=−60 to Yellow=+60). Bleaching or whitening is understood as an increse of 1 unit or more, preferably 2 units or more, in the L-component. In addition, cheeses were evaluated visually in comparison experiments (control vs experimental) for whiteness.

### EXAMPLE 5

### Bleaching of Cheese with Lipoxygenase (LOX)

Mini cheeses were prepared as described in Example 3 in which the cheese were spiked with a β-carotene casein emulsion (5 g β-carotene (DSM) was mixed with 25 g butterfat (AVEVE) at 50-60° C.; 25 ml of this were added to 50 ml of 0.1% sodium-caseinate solution followed by vigorous mixing using an Ultraturrax blender. 10 ml of this β-carotene solution were added to 200 ml cheese milk). LOX (84 U/ml cheese milk) was added; in a control experiment heat-inactivated LOX was added. The LOX originated form Sigma (Sigma LOX I-B, coded LOX Sigma, almost colourless). Bleaching was assessed by visual inspection, and the results are given in the table 1 below:

TABLE 1
Cheese color of LOX treated cheeses.

| | Cheese |
|---|---|
| Cheese additive | colour |
| No additives | ++ |
| LOX Sigma | + |
| LOX Sigma | ++ |
| (inactivated) | |

+: almost no color,
++: color of the control cheese,
+++: more intense color than the control cheese with no additives.

The results clearly show that Sigma LOX is able to bleach the color in the cheese.

### EXAMPLE 6

### Bleaching of Cheese by Direct Application of LOX

Sigma LOX (100 μl of a stock solution containing 168 U/μl) was directly spotted onto slices (approximately 2 mm thick) of commercially available Gouda cheese and incubated at 30° C. for 1 hour. In a control experiment, water was used instead of LOX. After 1 hour, the color of the treated spots on the cheese slices was determined as described in example 4. The L-value of the cheese treated with Sigma-LOX was slightly higher than the L-value of the cheese, treated with water (L=83 vs L=82). Both were higher than the L-value of the untreated cheese (L=81), indicating that both treatments resulted in bleaching, which was confirmed by visual inspection. The data indicated that the treatment with water causes bleaching of the cheese as result of extraction of the β-carotene and Anatto (a common colorant in Gouda cheese), which is a well known phenomenon. Still, the treatment with LOX gave a stronger discoloration, indicating that LOX treatment results in bleaching of the yellow color.

### EXAMPLE 7

### Treatment of Whey with Lipoxygenase

Whey was obtained form the mini cheese experiments, and Anatto (DSM) was added (2 μl/100 ml whey). A solution of Sigma LOX was added (84 U/ml whey) and the samples were incubated at 30° C. for 20 hours. In a control experiment, either water or heat-inactivated Sigma LOX was added. The samples were than filtered over a 0.2 μm filter, after which the color intensity was determined at 460 nm. The LOX-treated whey had a clearly lower absorbance (A=0.0045) compared to the whey to which either water or heat-inactivated LOX was added (which had absorbances of 0.090 and 0.092 respectively). The LOX treatment resulted in a clear reduction of the whey color.

1. A method for bleaching or whitening of a dairy product comprising incorporating lipoxygenase (LOX) into the dairy product.

2. A method according to claim 1, wherein LOX is incorporated before, during or after the production of the dairy product.

3. A method according to claim 1, wherein from 10 to 10000 units of LOX is added per gram of the dairy product.

4. A method according to claim 1, wherein the dairy product contains at least 10% w/w on dry solid basis of components of milk.

5. A method according to claim 1, wherein the dairy product is milk, cheese, butter oil, cream or whey products.

6. Use of a LOX to bleach a dairy product.

7. A use according to claim 5, wherein from 10 to 10000 units of LOX is used per gram of dairy product.

8. A use according to claim 6, wherein the dairy product contains at least 10% w/w on dry solid basis of components of milk.

9. A use according to claim 6, wherein the dairy product is milk, cheese, butter oil, cream or whey products.

10. A dairy product which is bleached by LOX or bleached by a method according to claim 1.

11. A dairy product comprising a LOX.
